(19) United States
(12) Patent Application Publication
(10) Pub. No.: US 2014/0025310 A1
(43) Pub. Date: Jan. 23, 2014

(54) METHOD FOR DETERMINING THE EFFICACY OF A COMBINATION THERAPY

(71) Applicant: Bart Reginald Alfons Winters, Belgium (BE)

(72) Inventor: Bart Reginald Alfons Winters, Belgium (BE)

(73) Assignee: VIRCO BVBA, Belgium (BE)

(21) Appl. No.: 14/029,994

(22) Filed: Sep. 18, 2013

(30) Foreign Application Priority Data
Jun. 30, 2009 (EP) EP 09164150.6

(51) Int. Cl. G06F 19/00; G06F 19/18

(52) U.S. Cl. CPC G06F 19/3431; G06F 19/18; G06F 19/3437
USPC 702/19

(57) ABSTRACT

The present invention concerns the determination of weighted phenotypic sensitivity score (wPSS) for a combination therapy as being the combination of information about the inherent anti-viral potency of each drug, as determined through statistical analysis of response to anti-retroviral therapy combination regimens, with resistance information on the individual patient's virus to each anti-retroviral drug as well as the use of this wPSS for predicting the efficacy of a patient's therapy or for evaluating or optimizing a therapy.

The current invention concerns the determination of weighted phenotypic sensitivity score (wPSS) for a combination therapy as being the combination of information about the inherent anti-viral potency of each drug, as determined through statistical analysis of response to anti-retroviral therapy combination regimens, with resistance information on the individual patient's virus to each anti-retroviral drug as well as the use of this wPSS for predicting the efficacy of a patient's therapy or for evaluating or optimizing a therapy.

Highly active anti-retroviral therapy (HAART) has been well documented to decrease HIV-1 RNA viral load as well as HIV-1-associated morbidity and mortality. Unfortunately, incomplete virologic suppression or even virologic rebound can occur in treatment naive or treatment-experienced patients. Persistent viral replication in the setting of drug selection can lead to the appearance of amino acid substitutions that confer resistance to the current regimen. Thus, identification of patients with primary (transmitted) or acquired drug resistance mutations is critical to achieve virologic suppression and improve patient outcome. To this end, testing for resistance to anti-retrovirals is standard of care, and current guidelines recommend resistance testing prior to initiation of antiretroviral therapy and at each treatment failure

Resistance testing is important in guiding the medical management of HIV-1-infected individuals and has been shown to improve virologic response but it remains unclear which method of resistance testing is most useful. Currently, there are three methods to evaluate HIV-1 resistance: genotype, phenotype, and virtual phenotype which are further described below in more detail. Determining which interpretation model is most sensitive and valid is a subject of ongoing intense investigation as there are advantages and disadvantages to each. Improved strategies to interpret viral resistance are necessary to predict the complex relationship between drug effects and virologic and immunologic outcomes.

As the number of available anti-retroviral agents has increased, so has the number of possible drug combinations and combination therapies. However, it is not easy for the physician to establish the optimal combination for an individual. Viral Load and CD4 count are commonly used as markers of when to begin therapy, and of the efficacy of that therapy. Current guidelines define the goal of therapy as suppression of viral load to <50 copies/mL of plasma in all patients, regardless of prior treatment experience. An increase in viral load is a warning that control of viral replication is being lost and that a change in therapy is required. Viral load, however, provides no information or guidance regarding which drugs should be used.

From the above it can be deducted that the difficulty in treating a HIV patient is to correctly combine several drugs, so called HAART, in order to obtain an optimal treatment response.

Knowledge of the resistance patterns of different inhibitors and the patient's treatment history can help. Resistance emergence is often correlated treatment failure. The interactions between different viral mutations related to different inhibitors is so complex that selecting the optimal treatment combination with only a treatment history to go on is far from ideal. Drugs can be ruled out unnecessarily and ineffective drugs can be introduced. Even if the virus is resistant to just for instance one of three drugs in a treatment regimen, this can allow low-level viral replication to take place and viral strains resistant to the other two drugs to develop.

It is clear that although there are many drugs available for use in combination therapy, the choices can quickly be exhausted and the patient can rapidly experience clinical progression or deterioration if the wrong treatment decisions are made. Tailored individualized therapy will include the effective profiling of the individual patient's virus population in terms of sensitivity or resistance to the available drugs. The aim of resistance monitoring is to provide the physician information about which drugs are unlikely to be active against an individual patients virus, thus enabling prescription of the most optimal drug combination for the individual patient. At present, there are three distinct approaches to measuring resistance:

The first approach involves phenotyping, which directly measures the actual sensitivity of a patient's pathogen or malignant cell to particular therapeutic agents. For example, HIV-1 phenotype testing directly measures HIV-1 drug resistance, detected as the ability of HIV-1, taken from a patient, to grow in the presence of a drug, in the laboratory. The phenotype is measured, for example expressed as an IC₅₀ or as a fold resistance for a particular drug, which is defined as the concentration of drug required to kill half of the virions in a sample. This is compared to the IC₅₀ for the drug using wild type virus. The phenotype is usually described or can be expressed in terms of the fold increase in IC₅₀ for each of the drugs.

The second approach to measuring resistance involves genotyping tests that detect specific genetic changes (mutations) in the viral genome which lead to amino acid changes in at least one of the viral proteins, known or suspected to be associated with resistance.

There are a number of techniques for conducting genotyping, such as hybridization-based point mutation assays, allele specific amplification assays and DNA sequencing (either by conventional Sanger sequencing or by the most recent available 454-pyrosequencing technique from Roche).

Although genotyping tests can be performed more rapidly, a problem with genotyping is that there are many individual mutations with evidence of an effect on susceptibility to HIV-1 drugs and new mutations are constantly being discovered, in parallel with the development of new drugs and treatment strategies. The relationship between these point mutations, deletions and/or insertions and the actual susceptibility of the virus to drug therapy is extremely complex and interactive. An example of this complexity is the M184V mutation that confers resistance to 3TC but reverses AZT resistance. The 333D/E mutation, however, reverses this effect and can lead to dual AZT/3TC resistance.

Consequently, the interpretation of genotypic data is both highly complex and critically important. There have been a number of different approaches to this challenge of interpretation. For example, armed with the knowledge of the main resistance mutations associated with each drug and the patient's recent treatment history, a physician makes a decision as to the optimum treatment. To assist physicians to make these judgments, various expert opinion panels have been convened and have published guidelines. In addition, rules-based algorithms constitute another approach. This is essentially a formalized version of the above with tables giving the mutations which are associated with resistance to each of the drugs. These can be simple printed tables or the information can be used to develop a rules-based computer algorithm. However, given the large number of mutations that are involved in resistance to anti-retroviral drugs and given the complex interactions between the mutations, the shortcoming of genotyping is the reliable interpretation and clinical application of the results. As more drugs become available and as more mutations are involved in the development of resistance, the ‘manual’ or rules-based interpretation of raw genotype data became rapidly impossible due to an increase in complexity.

A solution to this problem set forth above involves a method for measuring drug resistance by correlating genotypic information with phenotypic profiles.

This method, as a third approach to measure or predict resistance, brings together the knowledge of both a genotypic and a phenotypic database, and determines a (virtual) phenotypic fold resistance value without actually having to do phenotypic testing. The genotypic database contains the mutations in the tested HIV compared with the reference HIV (wild type). The phenotypic database contains phenotypic resistance values for the tested HIV, with a fold resistance determination compared to the reference HIV (wild type). This analysis may be done by comparing the sequence of the HIV sequence under test, e.g. obtained from a patient sample, against the stored sequences and by selecting “similar sequences”. Phenotypic data is then gathered for those “similar sequences” and the mean or median fold resistance may be calculated from the selected phenotypic values. This value is called “Virtual Fold Resistance”, which leads to the “Virtual Phenotype.” This technology is described in the published patent application WO 01/79540. Another quantitative prediction method for the analysis of drug resistance in HIV-1 is disclosed in WO 2004/111907 allowing the identification of primary and secondary resistance-associated mutations for new and existing drugs and for calculating the contribution of mutations (and combinations of mutations) to resistance and hyper-susceptibility.

Interpretation of HIV-1 genotypic drug resistance is evolving from rule-based systems by expert opinion such as Stanford HIVdb, Rega or ANRS to data-driven engines developed through machine learning methods such as Support Vector Machine (SVM), artificial Neural Network and the like.

New data and new therapeutic treatment regimens continue to modify the treatments available, and it is difficult for all but the specialist to remain current on the latest treatment information. Even those physicians who are current on the latest treatment information require time to assimilate that information and understand how it relates to other treatment information in order to provide the best available treatment for a patient.

Interpretation algorithms provide a resistance call for each available HIV drug. Often this is a three way classification i.e. sensitive (a score of 1), intermediate resistant (a score of 0.5) or resistant (a score of 0). For VircoType (WO 01/79540) the interpretation is for instance based on a statistical model, leading to the definition of so called clinical cut-offs (CCO), that predicts the % activity of a drug (i.e. the susceptibility score) as a function of fold change at the start of the regimen. The % activity left was calculated by dividing the predicted viral load change for the patients' virus with a certain resistance profile by the predicted viral load for a wild-type virus. This is an ordinal value that varies between 0% (or a score of 0) and 100% (or a score of 1). Based on these values, clinical cutoffs (phenotypic threshold values) were derived to classify a virus sample into maximal response, reduced response and minimal response as described in WO 2005/086061. Clinical cutoffs were defined as the fold change at which respectively a moderate amount (20%) or most (80%) of the drug's activity is lost.

The activity of a combination regimen is often expressed as a phenotypic or genotypic sensitivity score (PSS/GSS) calculated as the sum of activities of all individual drugs in a regimen (from 1 being fully sensitive, to 0 meaning fully resistant). However, the efficacy of a combination regimen does not only depend on the resistance profile of the virus, but also on the ability of individual drugs to diminish the viral load in patient's plasma. Therefore, the score should also take into account drug specific characteristics such as potency of a drug in order to be useful for individual patient care.

In view of the foregoing, an object of the invention is to provide a method for developing a weighted sensitivity score to assess the activity of a combination regimen. The method according to the invention is a data driven weighted sensitivity score for combination therapies combining drug resistance factors and drug weights (for a drug class or individual drug specific) in order to obtain a score that is highly predictive of virological outcome wherein the probability of a successful drug combination increases with an increasing score.

In accordance with the method of the invention is the determination of a weighted phenotypic sensitivity score (wPSS) as being the combination of information about the inherent antiviral potency of each drug or drug class, as determined through statistical analysis of response to anti-retroviral therapy combination regimens, with information about the susceptibility of the individual patient's virus to each anti-retroviral drug. The information about the susceptibility of the patient's virus is preferably being represented as a susceptibility score, optionally by the resistance call by one of the commonly used genotypic interpretation algorithms. Interpretation algorithms provide a resistance call for each available HIV drug. Often this is a three way classification i.e. sensitive (a score of 1), intermediate resistant (a score of 0.5) or resistant (a score of 0).

In one embodiment, the current invention is related to a method for determining the weighted phenotypic sensitivity score by adding up the contribution of each drug to the overall regimen activity. The contribution of each drug is determined by multiplying said drug weight or drug-class weight factors (drug potency) and said drug susceptibility score. Said potency of said drug is determined through statistical analysis of response to therapeutic combination regimens. The statistical analysis is performed by a linear regression model or a causal inference model such as a marginal structural models, propensity score grouping or double robust estimation.

The drug is an anti-retroviral drug such as any HIV drug and can be selected from the group consisting of HIV protease inhibitors (PI), HIV non-nucleoside reverse transcriptase inhibitors (NNRTI), HIV nucleoside and nucleotide reverse transcriptase inhibitors (NRTI), HIV entry or fusion inhibitors (FI), HIV integrase inhibitors (IN) or HIV maturation inhibitors.

In a second embodiment the method according to the invention is used for the prediction of efficacy of a patient's therapy or for evaluating or optimizing a therapy.

In addition part of the invention is the use of the weighted phenotypic sensitivity score as determined by above described method for the prediction of efficacy of a patient's therapy or for evaluating or optimizing a therapy.

Basically the method of the invention is performed in two steps:

1^{st} Step:

Drug specific and drug class specific weights are derived from a diverse clinical outcome data base, consisting of both clinical cohorts and clinical trials. These weights are derived by comparing the response of patients receiving a particular drug to the response of patients receiving a reference drug. The difference in clinical response are the weights and they are determined using a statistical model able to cope with imbalances with respect to other characteristics (patient, virus or treatment characteristics) that may affect clinical response and that may be confounded with the drugs to be compared. Statistical methods used include linear regression models (corrected for censoring or not in order to handle viral loads below the detection limit of the viral load test kits), causal inference models (marginal structural models, propensity score grouping or double robust estimation).

2^{nd} Step:

The weights in 1^{st} step above described are combined with the resistance factors associated with the patient's virus and information on which drug combination is being evaluated in order to obtain a weighted score.

### EXAMPLES

A Treatment Change Episode (TCE) is defined as a period in a patient's treatment history containing all the information to assess the impact of resistance and drug use on viral load. This means that the patient should receive a stable known antiretroviral treatment combination. A viral load measurement should be available shortly before or at the start of treatment and 8 or 24 weeks after starting the treatment combination. Furthermore the resistance information on the patient's virus should be available at baseline.

A clinical outcome dataset consisting of clinical trial and cohort data of which 5426 Treatment Change episodes (TCE) were used for development of the weights and 1923 TCE were reserved for validation purposes. Susceptibility scores were defined as the % activity derived from the clinical cut-off models as previously explained (WO 2005/086061). Drug weights were derived by comparing the viral load change observed for a certain compound with the viral load change observed with a reference compound. As the populations were not randomized, differences between groups may be due to other characteristics than the presence of a particular Pl. Therefore, statistical models were applied to handle these differences. Drug specific weights for HIV-1 protease inhibitors were derived using linear regression models, marginal structural models and a double robust estimator in order to handle imbalances between the groups. Imbalances with respect to the baseline viral load, number of active NRTIs and NNRTI's taken in addition to the PI were taken into account. The number of active NRTI's was calculated by summing up the susceptibility scores of all individual NRTI's in the regimen. In this example, the reference compound was the ritonavir boosted protease inhibitor lopinavir and was assigned an arbitrary weight of 1. All other protease inhibitors were compared to lopinavir with respect to the change in viral load observed after 8 weeks of stable treatment using double robust estimation. The difference in viral load response (log scale) was added to the reference weight of 1 to obtain the weight for the comparator PI. E.g. The difference in viral load change between patients taking atazanavir and patients taking lopinavir was −0.02 log viral load. Therefore the drug weight for atazanavir was determined as −0.02. Drug weights for other PI's are presented in table 1 below.

TABLE 1
Weights derived using double robust estimation.

| Drug (PI) | Weight |
|---|---|
| LPV/r | 0 |
| ATV/r | −0.02 |
| IDV/r | −0.26 |
| FPV/r | −0.31 |
| NFV/r | −0.46 |
| TPV/r | −0.36 |
| DRV/r (800 mg QD) | 0.25 |
| DRV/r (600 mg BID) | 0.57 |

For other drugs, no final weight was calculated yet, so a neutral 0 was assigned.

The PI susceptibility scores, as defined above, were multiplied with the PI drug weights and these weighted susceptibility scores were used to derive drug-class weights. Drug-class weights were derived in a similar way as the drug weights. E.g. The weight of the PI drug class was determined by the difference in viral load changes for patients taking a PI and patients taking no PI with respect to the change in viral load. Similar statistical models as for the drug weights were used to correct the analysis for other drug classes taken in addition (NNRTI's, NRTI's, Fusion Inhibitors, . . . ). The table below shows an overview of the drug-class weights.

TABLE 2
Drug-class weights derived using double robust estimation

| Drug Class | # Active NRTIs | Weight |
|---|---|---|
| PI | | 1.10 |
| NNRTI | | 1.05 |
| NRTI | 0 | 0 |
| | 1 | 0.35 |
| | 2 | 1.16 |
| | >2 | 1.22 |

Using the susceptibility scores, the drug weights and drug-class weights the weighted phenotypic sensitivity score is calculated as follows:

wPSS=Σ((Weight_{DRUG Class i}+Weight_{DRUG i})×SS_{DRUG i})+Weight_{NRTI}

with:
Weight_{DRUG Class i}: the drug class weight of drug i in the regimen if drug i is not an NRTI Weight_{DRUG i}: the drug weight of drug i in the regimen if drug i is not an NRTI
SS_{DRUG i}: the susceptibility score of a drug i in the regimen if drug i is not an NRTI
Weight_{NRTI}:is chosen from table 2 based on the sum of susceptibility scores of all the NRTI's in the regimen.

### EXPLANATION OF FIGURES

FIG. 1: Response rates at week 8 and week 24 in cohort patients (A) and trial patients (B). The size of the bubble is proportional to the number of Treatment Change Episodes with wPSS in each category As illustrated in FIG. 1, the wPSS is well correlated with virologic response in clinical trials while most patients in the cohort population had a similar wPSS.

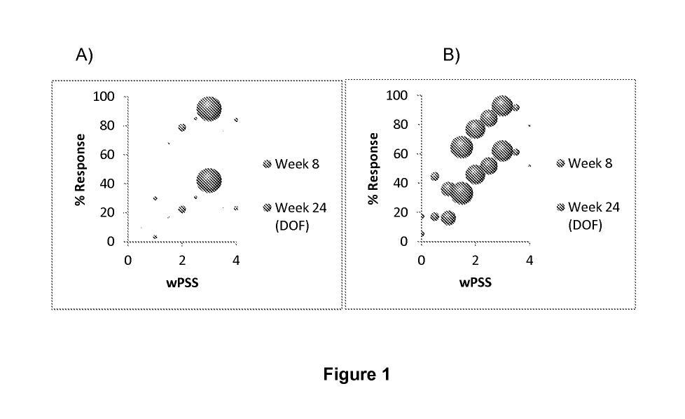

FIG. 2: Response rates predicted by logistic regression for cohort (A) or clinical trial (B) patients. Based on FIG. 2 the wPSS can be associated with an expected response rate. Using the “Drop-Out as Failures” analysis, the response rate in clinical cohorts at week 24 is reduced because of changes in treatment regimens for reasons other than virologic failure.

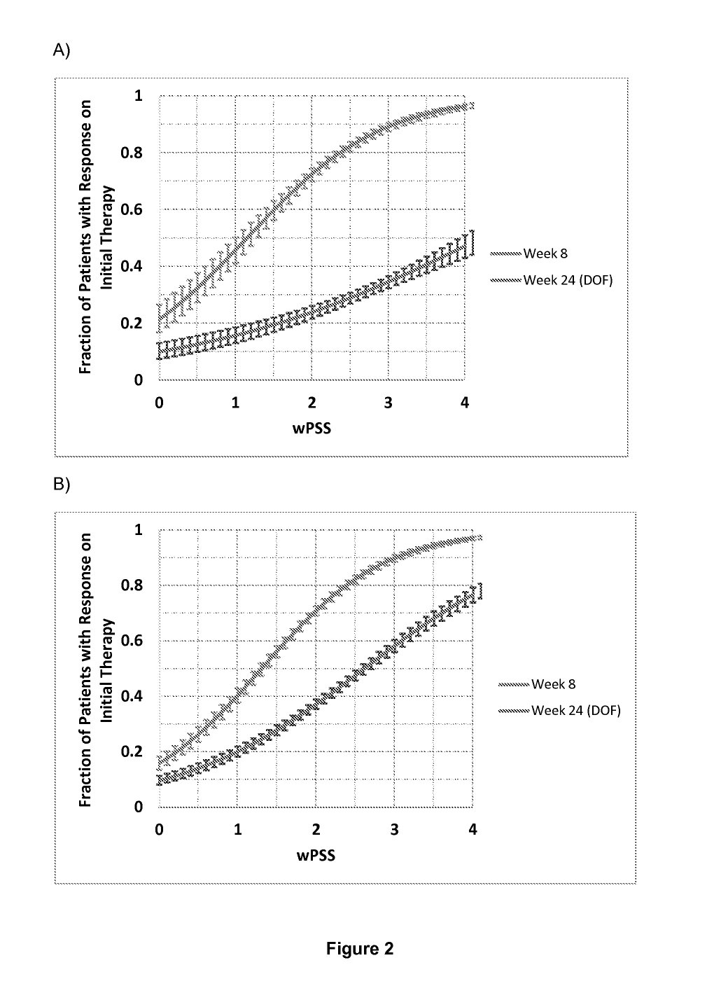

### EXAMPLE

Patient 1: The wPSS for a regimen including 2 active NRTIs (DDI and TDF with susceptibility score of 1), LPV/r (a PI with a susceptibility score of 0.24 for this virus) and no NNRTIs is 1.16+1.10×0.24=1.42.

Patient 2: The wPSS for a regimen including 2 active NRTI (TDF with a susceptibility score of 1 and 3TC with a susceptibility score of 0.94, ATV/r (with a susceptibility score 1) and EFV (a fully active NNRTI) is 1.16+(1.10−0.02)×1+1.05×1=3.29.

As a result, the treatment in patient 2 has a higher probability of success.

The performance of the weighted PSS score was compared with the un-weighted PSS, ANRS and HIVDB algorithm and the REGA algorithm weighted by drug class on a validation data set (data not used for the development of the weights). The ANRS, HIVDB and REGA algorithms are resistance interpretation algorithms, as found on their respective web sites, which score the susceptibility of a virus as 1 (susceptible), 0.5 (intermediate resistant) or 0 (resistant). The performance was assessed by the diagnostic accuracy, a measure of the percentage regimens that were correctly predicted to be regimen successes or regimen failures.

Diagnostic accuracy (AUC under the ROC curve) was based on a logistic regression model, modeling response (defined as a 1 log drop at week 8 and as undetectable at week 24) as a function of baseline VL, weighted, and enfuvirtide (initially designated as T-20) use.

In the overall population, the diagnostic accuracy in predicting response at week 8 of the model including the weighted PSS was 82% vs 78% for the un-weighted PSS. The accuracy dropped to 76% and 70% at week 24 (drop-outs considered as missing) for the weighted and the un-weighted scores respectively. When restricting the analysis to the salvage regimens, the accuracy was 79% and 71% at week 8, and 80% and 66% at week 24 for the weighted and un-weighted scores. These results indicate that a weighted PSS allows for a better prediction of the effect of a combination regimen. Refer to Table 3 for more details: the accuracy was evaluated at week 8 and week 24. At week 8 response was defined as a viral load drop of 1 log. At week 24 response was defined as an undetectable viral load. At week 24 patient drop-outs were handled by considering them as missing (DOM), or by considering them as treatment failures (DOF).

TABLE 3
Diagnostic Accuracy of different interpretation systems
using different definitions of virological response and
in different populations (Validation data set)

| | | | Based on | | Based on other | | |
|---|---|---|---|---|---|---|---|
| | | | vircoTYPE | | interpretation systems | | |
| | | N | PSS | wPSS | ANRS | HIVDB | REGA |
| All | Week 8 | 1923 | 78% | 82% | 76% | 76% | 78% |
| patients | (1 Log | | | | | | |
| | VL drop) | | | | | | |
| | Week 24 | 1143 | 70% | 76% | 68% | 69% | 72% |
| | (Un- | | | | | | |
| | detectable | | | | | | |
| | VL/DOM) | | | | | | |
| | Week 24 | 1923 | 60% | 70% | 59% | 58% | 63% |
| | (Un- | | | | | | |
| | detectable | | | | | | |
| | VL/DOF) | | | | | | |
| Very | Week 8 | 749 | 71% | 79% | 69% | 66% | 72% |
| treat- | (1 Log | | | | | | |
| ment | VL drop) | | | | | | |
| experi- | Week 24 | 586 | 66% | 80% | 63% | 62% | 70% |
| enced | (Un- | | | | | | |
| patients | detectable | | | | | | |
| only | VL/DOM) | | | | | | |
| | Week 24 | 749 | 67% | 79% | 64% | 62% | 71% |
| | (Un- | | | | | | |
| | detectable | | | | | | |
| | VL/DOF) | | | | | | |

1. Method for determining a weighted phenotypic sensitivity score by combining drug specific characteristics and the susceptibility of an agent to a drug in a particular regimen.

2. Method for determining the weighted phenotypic sensitivity score for a combination regimen according to claim 1 wherein said drug specific characteristic is the potency of said drug.

3. Method according to claim 2 wherein the potency of said drug is quantified by weight as determined through statistical analysis of response to therapeutic combination regimens.

4. Method for determining the susceptibility of a drug according to claim 1 wherein the susceptibility is a score as determined by clinical cut-off models.

5. Method according to claim 1 wherein the agent is a virus or a bacterium.

6. Method according to claim 5 wherein the virus is HIV and wherein the drug is an anti-retroviral drug such as a HIV drug.

7. Method according to claim 3 wherein the statistical analysis is performed by a linear regression model or a causal inference model such as a marginal structural model, propensity score grouping or double robust estimation.

8. Method according to claim 1 wherein the drug is selected from the group consisting of HIV protease inhibitors, HIV non-nucleoside reverse transcriptase inhibitors, HIV nucleoside and nucleotide reverse transcriptase inhibitors, HIV entry or fusion inhibitors, HIV integrase inhibitors or HIV maturation inhibitors.

9-10. (canceled)
